(19) United States
(12) Patent Application Publication
(10) Pub. No.: US 2020/0076786 A1
(43) Pub. Date: Mar. 5, 2020

(54) Systems, methods and apparatuses To Perform Self-Authentication

(71) Applicants: Bruce Ha, Redmond, WA (US); Nova Spivack, Redmond, WA (US)

(72) Inventors: Nova Spivack, REDMOND, WA (US); Bruce Ha, REDMOND, WA (US)

(21) Appl. No.: 16/559,872

(22) Filed: Sep. 4, 2019

Related U.S. Application Data
(60) Provisional application No. 62/726,829, filed on Sep. 4, 2018.

(51) Int. Cl. H04L 29/06; H04W 12/06; G06K 9/00; G06F 21/44; G06Q 20/40; G06Q 20/38; H04L 9/32

(52) U.S. Cl. CPC H04L 63/08; H04W 12/06; G06K 9/00577; G06F 21/44; H04L 2209/56; G06Q 20/3827; H04L 9/3239; H04L 2209/38; G06Q 20/40

(57) ABSTRACT

Systems, methods and apparatuses to perform self-authentication are disclosed. In one aspect, embodiments of the present disclosure include a method, which may be implemented on a system, to perform authentication using a tag. The method can further include retrieving a unique identifier from the tag. A second unique identifier is used to determine lighting parameters to be used by the mobile device to illuminate the tag. The method can include, illuminating the tag using the lighting parameters determined and capturing an image generated from the tag in response to illumination of the tag using the lighting parameters. A mathematical representation derived from the image can then use used to generate a hashing function used in authentication.

### CLAIM OF PRIORITY

This application claims the benefit of:
U.S. Provisional Application No. 62/726,829, filed Sep. 4, 2018 and entitled “Systems, Methods and Apparatuses of a Self-Authentication Tag,” (8001.US00), the contents of which are incorporated by reference in their entirety.

### RELATED APPLICATIONS

This application is related to PCT Application No. PCT/US2019/______, filed Sep. 4, 2019 and entitled “Systems, methods and apparatuses To Perform Self-Authentication” (8001.WO01), the contents of which are incorporated by reference in their entirety.

### TECHNICAL FIELD

The disclosed technology relates generally to systems, methods and apparatuses of a self-authenticating device.

### BACKGROUND

With the advent of modern distribution, the channels can be complex with many points of handling. For high value items or where items can cause catastrophic failures if faked, there is a need to authenticate the product and provide traceability for the life of the product to obfuscate counterfeiters making knock offs.

Some security devices utilize holographic labels and secure RFid to attach to the objects to create overt and covert authentication. However, the security features can be compromised. Security holograms can be constructed with a dot matrix and even e-beam systems. Although they can be difficult to copy, a mimic can be created to trick untrained eyes. Secure RFid's are another way to create security to protect the product. These devices have built in algorithms that will create a hash from an input with a selected but published number internal to the circuitry. However, the output signals can be intercepted and attached to a fake to produce the same signal and introduced to the authentication device as authenticated.

### BRIEF DESCRIPTION OF THE DRAWINGS

FIG. 1 illustrates example diagrams of a tag having diffractive features with varying appearances under different lighting conditions, in accordance with embodiments of the present disclosure.

FIG. 2 depicts an example of using a mobile device to authenticate the tag, in accordance with embodiments of the present disclosure.

FIG. 3A depicts a flow chart illustrating an example process to use diffractive features of a tag for authentication, in accordance with embodiments of the present disclosure.

FIG. 3B depicts a flow chart illustrating an example process to use unique features of an object to authenticate the object itself, in accordance with embodiments of the present disclosure.

FIG. 4A depicts an example functional block diagram of a client device such as a mobile device that can be used to determine authentication of a tag or object, in accordance with embodiments of the present disclosure.

FIG. 4B depicts an example functional block diagram of a client device such as a mobile device that can be used to determine authentication of a tag or object, in accordance with embodiments of the present disclosure.

FIG. 5 depicts an example flow for generating a hash function and hash value used for authentication, in accordance with embodiments of the present disclosure.

FIG. 6 is a block diagram illustrating an example of a software architecture that may be installed on a machine, in accordance with embodiments of the present disclosure.

FIG. 7 is a block diagram illustrating components of a machine, according to some example embodiments, able to read a set of instructions from a machine-readable medium (e.g., a machine-readable storage medium) and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Authentication can include a process that receives or retrieves an input and creates a hash of a given length using a secret or private key. The secret/private key can be for example, encoded in an inaccessible location on a computing device (e.g., a mobile phone or other computing system). In general, the hash can be sophisticated enough to thwart and prevent anyone from attempting to determine the input from the hash, if the hash were known. Therefore, the process can be designed to be asymmetrical in calculation speed or asymmetrical in computing resource requirements.

For instance, the calculation for the hashing process can be short while the calculation to find the input using the hash can be very long in comparison, even with super-fast computers with vast computing resources. The hash therefore can be made public while the secret key or private key is kept known only to the owner. Embodiments of the present disclosure utilize the unique features of the object being protected to be a private key. The object can simply be a tag (e.g., the security tag) to be applied to an object or the object itself.

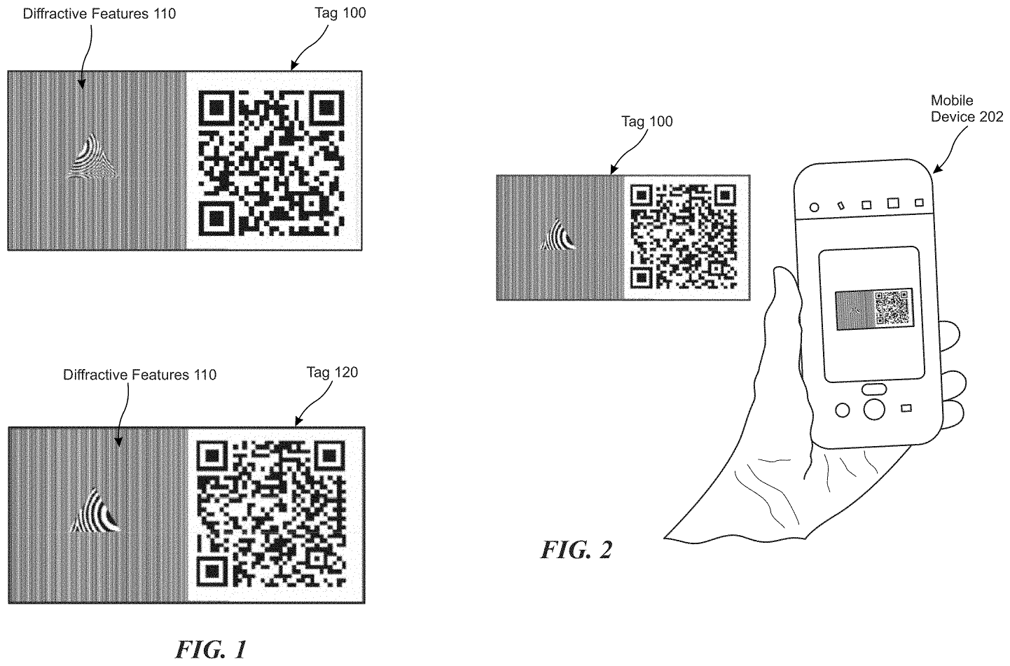

In the case where the object is the tag, the patent relies on technology patented by Stamper Technologies, Inc. in U.S. Pat. Nos. 8,264,757, 8,717,650, 7,961,367, 7,830,573 where different images can be read on different planes of the tag. With diffractive elements on the tag, there can be trillions of different discrete images as a function of the designs, various viewing angles and different lighting conditions, as illustrated in the example of FIG. 1.

FIG. 1 illustrates example diagrams of a tag 100 (e.g., as security device or security tag) having diffractive features with varying appearances under different lighting conditions, in accordance with embodiments of the present disclosure.

Embodiments of the present disclosure contemplate using one of these images showing one image 110 of the diffractive features or a second image 120 of the diffractive features of the tag as a seed for the hashing function in an authentication process. Since a unique image can be produced only at a particular viewing angle and lighting condition, it would take a very long time to guess which viewing angle and lighting condition was used as the hashing function.

Specifically, the tag 100 (e.g., the security device or security tag) which self-authenticates, has an optically diffractive surface which has multiple diffractive elements (e.g., optically diffractive elements). The multiple diffractive elements of the tag 100 are configured to generate a complex light wavefront in response to illumination by a light source and therefore, the appearance of the multiple diffractive optical elements can change when illuminated under different lighting conditions.

For example, the diffractive features of the diffractive optical elements of the tag 100 under a first lighting condition (e.g. with the lighting at a first angle, or the tag at a first angle with respect to a light source) can appear as shown in 110. The diffractive features of the diffractive optical elements of the tag 100 under a second lighting condition (e.g. with the lighting at a second angle, or the tag at a second angle with respect to a light source) can appear as shown in 120. The complex light wavefront generated from the diffractive elements of the tag 100 can be used to create a hash value for authentication.

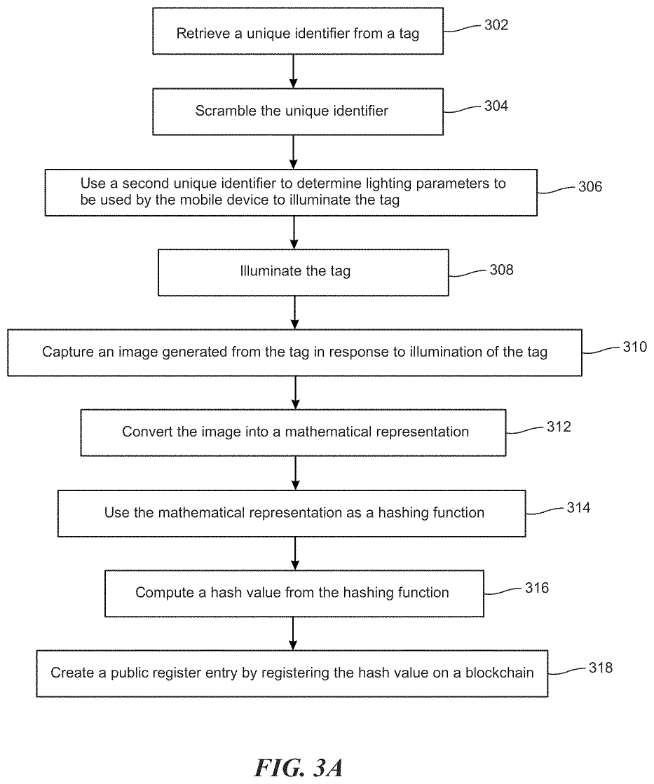

FIG. 2 depicts an example of using a mobile device 202 to authenticate the tag 100, in accordance with embodiments of the present disclosure.

The tag 100 can include one or more fiducial markers which have machine-readable or computer-readable code (e.g., a barcode or QR code). The mobile device 202, in performing authentication of the tag, can parse the fiducial marker(s) and identify a unique identifier associated with the tag 100. The unique identifier can then be used (e.g., by the mobile device 202) to generate a mathematical representation of the digital images of the complex light waveform. The hash value used for authentication of the tag 100 can then be created from the mathematical representation of the multiplexed digital image and another mathematical representation of the fiducial marker. The fiducial marker becomes a part of the hash along with the diffractive patterns.

Note that, the complex light wavefront can include digital images viewable in different planes, for example, relative to a reflected signal from the light source. The digital images are able to be uniquely discriminated relative to the fiducial marker and the fiducial marker is substantially immutable when illuminated by the light source. The light source can be provided by an LED light source. The LED light source can be provided by a mobile system such as the mobile device 202.

Configuration data can be generated for the multiple diffractive elements configured to produce the complex light wavefront. Each of the multiple diffractive optical elements can be recorded by exposing a rotating photosensitive substrate medium with a single non-referenced light beam. During the exposing, the rotating photosensitive substrate can rotate at an angular velocity greater than or equal to 10 revolutions per second. In general, the recording is performed absent other light interference of the single non-referenced light beam.

The client device or mobile device 202 can be any system and/or device, and/or any combination of devices/systems that is able to establish a connection with another device, a server and/or other systems. Mobile device 202 can typically include a display and/or other output functionalities to present information and data exchanged between among the devices.

For example, the mobile device 202 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, a wearable device, a head mounted device, a smart watch, a goggle, a smart glasses, a smart contact lens, and/or any other portable, mobile, hand held devices, etc. The input mechanism on mobile device 202 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

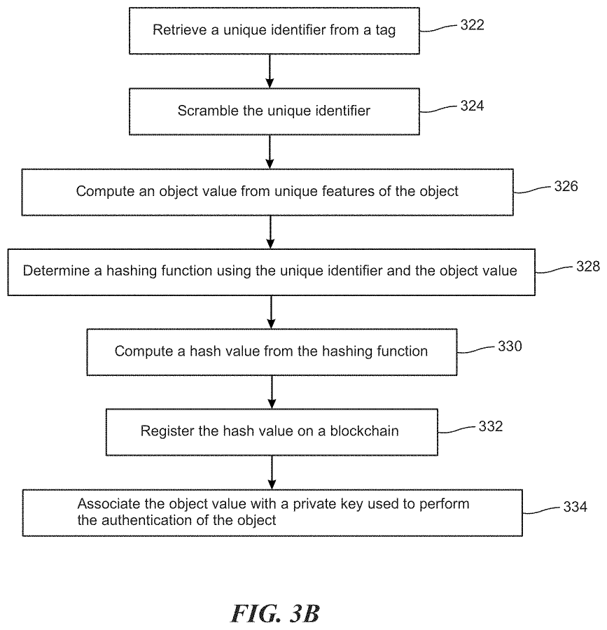

FIG. 3A depicts a flow chart illustrating an example process to use diffractive features of a tag for authentication, in accordance with embodiments of the present disclosure.

Embodiments of the present disclosure include a self-authentication device having a unique serialized identifier and/or unique features. The device can use the serialized identification to create a secure hash to link to a block chain using a set of characteristics unique to the device. The characteristics of the device or the object features are generally unpublished. Authentication is achieved when the serialized number is matched to the unique characteristics mathematically and logged onto the block chain ledger using a mobile device with access to a network. For example, the self-authentication device can publish a serialized number and keeps the unique characteristics of the device secret either in compiled code or other secured microelectronic devices (e.g., such as Apple's secret enclave).

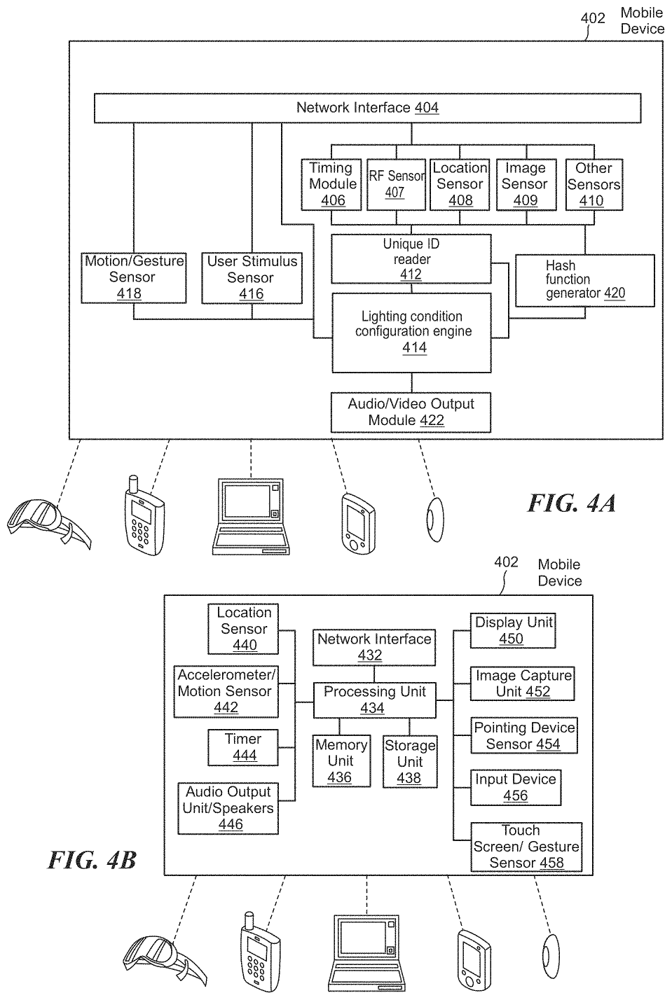

In process 302, a unique identifier is retrieved from a tag (e.g., a self-authenticating tag, a security tag, a security device, etc.). The tag can include an optically diffractive surface with multiple diffractive optical elements where an appearance of the multiple diffractive elements changes when illuminated. In one embodiment, the unique identifier can be detectable by LIDAR. The unique identifier can comprise of florescent chemical or an optical marking viewable at different spectrums. The unique identifier can also include a thermal source activated by electromagnetic radiation. The unique identifier can also include a printed unique identifier that is human readable. The unique identifier can also include a QR code or be provided in an RFiD. In one embodiment, the unique identifier can be retrieved by a mobile device (e.g., mobile device 202 of the example of FIG. 2 or mobile device 402 of the example of FIG. 4A).

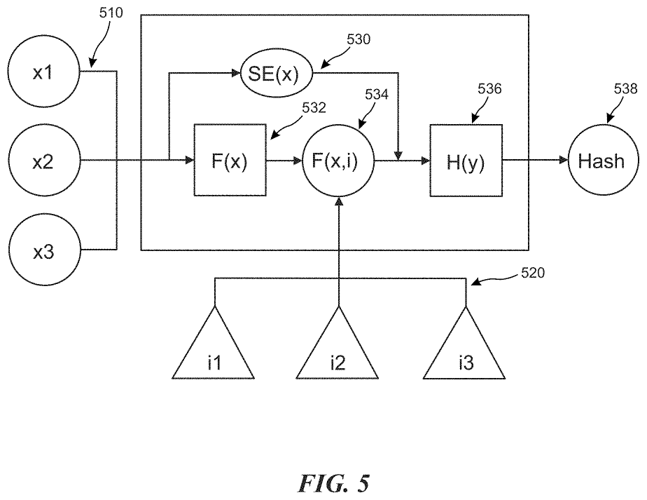

In process 304, the unique identifier (e.g., a unique serial number, input x1-x3 510 as shown in the example of FIG. 5) is scrambled. The unique identifier can be scrambled (e.g., function F(x) 532 as shown in the example of FIG. 5) by the mobile device (e.g., using secret code inside an application). The scrambling can also be performed by another device.

In process 306, a second unique identifier is used to determine lighting parameters to be used by the mobile device to illuminate the tag. For example, the second unique number can be used to determine an angle and/or set a lighting condition to illuminate the tag. For instance, there can be markers on the diffractive surface to indicate the reference angle for scanning the diffractive sequences. In one embodiment, a marker can be retrieved from the optically diffractive surface of the tag, where the marker can indicate the angle at which to illuminate the tag. The lighting parameters are determined at least in part from the angle at which to illuminate the tag by the mobile device.

A user can be instructed to rotate or tilt the tag to implement the lighting parameters as determined from the marker. The user can also be instructed to rotate or tilt the mobile device to implement the lighting parameters as determined from the marker.

In process 308, the tag is illuminated. Since the tag has multiple diffractive elements (e.g., inputs i1-i3 520 as shown in the example of FIG. 5), the tag will change appearance when illuminated. In process 310, an image generated from the tag in response to illumination of the tag is scanned or captured captured.

In process 312, the image is converted into a mathematical representation (e.g., as shown in F(x,i) 534 of FIG. 5). In process 314, the mathematical representation is used as a hashing function (e.g., H(y) 536 as shown in the example of FIG. 5). In process 316, a hash value (e.g., Hash 538 of FIG. 5) is computed from the hashing function (e.g., H(y) 536 as shown in the example of FIG. 5). In process 318, a public register entry is created by registering the hash value on a blockchain.

Authentication of the public register entry on the block chain is performed using a private key derived using the multiple diffractive optical elements. For example, an output value is computed by using the private key on the public register entry and it is determined whether the output value matches the unique identifier. The public register entry can be authenticated responsive to detecting a match between the output value and the unique identifier, and therefore, authentication of the tag is only achievable with the tag.

The tag can be formed in a sticker or label suitable for attachment or fixation onto an object. The label would be made to be tamper resistant by self-destroying if any attempt is made to remove it. For example, the tag can peel off in fragment and render it not recognizable as the original. The tag can also be embedded in a containment system such as glass and would be damaged to look different if broken. For instance, a coin can be such a containment system where the backing is made from metal but the visible section is covered by a transparent material such as glass or crystal.

Authentication for the tag can only be achieved with the tag. Since the unique serial number of the tag is allowed to be read, this can be easily copied. However, the diffractive features are inherently not copy able or cloned. Since the diffractive features are the mathematical key to unlock the public block chain hash value, the tag and anything that it attaches itself to, is secure.

An example of an application is for a crypto cash. A coin with embedded tag can be read and produce a hash. This hash is then associated with a transaction to load and unload the coin with a certain amount of money. The private key is exposed but the identity of the coin is simply the coin itself. It is not registered to any owner, except for the owner of the coin itself. Since the private key has been used, the coin is then destroyed. Otherwise someone can use the exposed private key to unload the rest of the currencies.

FIG. 3B depicts a flow chart illustrating an example process to use unique features of an object to authenticate the object itself, in accordance with embodiments of the present disclosure.

In process 322, a unique identifier is retrieved from a tag. In one embodiment, the unique identifier can be detectable by LIDAR. The unique identifier can comprise of florescent chemical or an optical marking viewable at different spectrums. The unique identifier can also include a thermal source activated by electromagnetic radiation. The unique identifier can also include a printed unique identifier that is human readable. The unique identifier can also include a QR code or be provided in an RFiD. In one embodiment, the unique identifier can be retrieved by a mobile device (e.g., mobile device 202 of the example of FIG. 2 or mobile device 402 of the example of FIG. 4A).

In process 324, the unique identifier is scrambled. The unique identifier can be scrambled (e.g., function F(x) 532 as shown in the example of FIG. 5) by the mobile device (e.g., using secret code inside an application). The scrambling can also be performed by another device. A further embodiment includes a secret enclave function (e.g., function SE(x) 530 as shown in the example of FIG. 5) that scrambles the unique identifier and becomes another part of the hashing function (e.g., H(y) 536 as shown in the example of FIG. 5). In some embodiments the secret enclave function can also be computed by another hardware device for additional security.

In process 326, an object value is computed from unique features of the object. Note that the object can include any object of value, such as, one or more of a mineral, a diamond and a work of art.

Embodiments of the present disclosure enables use of unique features of the object being protected to be a private key. As such, in process 328, a hashing function is determined using the unique identifier and the object value. In process 330, a hash value is computed from the hashing function. In process 332, the hash value is registered on a blockchain. In process 334, the object value is associated with a private key used to perform the authentication of the object. Therefore, authentication of the object is only achievable with the object itself.

FIG. 4A depicts an example functional block diagram of a client device such as a mobile device 402 that can be used to determine authentication of a tag or object, in accordance with embodiments of the present disclosure.

The client device 402 includes a network interface 404, a timing module 406, an RF sensor 407, a location sensor 408, an image sensor 409, a unique ID reader 412, a lighting condition configuration engine 414, a user stimulus sensor 416, a motion/gesture sensor 418, a hash function generator 420, an audio/video output module 422, and/or other sensors 410. The client device 402 may be any electronic device such as the devices described in conjunction with the mobile device 202 in the example of FIG. 2 including but not limited to portable devices, a computer, a server, location-aware devices, mobile phones, PDAs, laptops, palmtops, iPhones, cover headsets, heads-up displays, helmet mounted display, head-mounted display, scanned-beam display, smart lens, monocles, smart glasses/goggles, wearable computer such as mobile enabled watches or eyewear, and/or any other mobile interfaces and viewing devices, etc.

The unique ID reader 412 is able to read a unique serial number or other unique identifier from the tag (e.g., security tag). The unique identifier can be a printed unique serial number, a QR code with a unique serial number, and/or a wireless chip embedded in the tag that can provide a unique serial number. The unique identifier can also be scrambled by the client device 402.

The lighting condition configuration engine 414 can set the lighting condition with which to illuminate the tag. For example, the lighting condition configuration engine 414 can determine the angle to be used to illuminate the tag. The tag, having diffractive elements (i in FIG. 1), can change appearance when illuminated. An image of the diffractive elements can then be scanned by the client device 402 and converted into a mathematical representation (e.g., by the hash function generator 420). The mathematical representation can be used as a hashing function to create a hash value (e.g., a public hash key) to be registered to the block chain with a given transaction.

Additional or less modules can be included without deviating from the novel art of this disclosure. In addition, each module in the example of FIG. 4A can include any number and combination of sub-modules, and systems, implemented with any combination of hardware and/or software modules.

The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 4A, the network interface 404 can be a networking device that enables the client device 402 to mediate data in a network with an entity that is external to the host server, through any known and/or convenient communications protocol supported by the host and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

One embodiment of the client device 402 includes a processor (processing unit as shown in the example of FIG. 4B) coupled to the imaging sensor and memory coupled to the processor. The memory can have stored thereon instructions, which when executed by the processor, cause the processor to perform authentication of a tag using a tag.

The memory can have further stored thereon instructions, which when executed by the processor, cause the processor to: retrieve a unique identifier from the tag, scramble the unique identifier and use a second unique identifier to determine lighting parameters to be used by the client device 402 to illuminate the tag. The processor can further cause the client device 402 to illuminate the tag using the lighting parameters determined from the second unique identifier, capture an image generated from the tag in response to illumination of the tag using the lighting parameters and convert the image into a mathematical representation which can be used as a hashing function.

FIG. 4B depicts an example functional block diagram of a client device 402 such as a mobile device that can be used to determine authentication of a tag or object, in accordance with embodiments of the present disclosure.

In one embodiment, client device 402 (e.g., a user device) includes a network interface 432, a processing unit 434, a memory unit 436, a storage unit 438, a location sensor 440, an accelerometer/motion sensor 442, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for performing authentication. The network interface 432 has been described in the example of FIG. 4A.

One embodiment of the client device 402 further includes a processing unit 434. The location sensor 440, accelerometer/motion sensor 442, and timer 444 have been described with reference to the example of FIG. 4A.

The processing unit 434 can include one or more processors, CPUs, microcontrollers, FPGAs, ASICs, DSPs, or any combination of the above. Data that is input to the client device 402 for example, via the image capture unit 452, pointing device/sensor 454, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer that generates and controls access to simulated objects by way of a communications component.

One embodiment of the client device 402 further includes a memory unit 436 and a storage unit 438. The memory unit 436 and a storage unit 438 are, in some embodiments, coupled to the processing unit 434. The memory unit can include volatile and/or non-volatile memory.

In some embodiments, any portion of or all of the functions described of the various example modules in the client device 402 of the example of FIG. 4A can be performed by the processing unit 434. In particular, with reference to the mobile device illustrated in FIG. 4A, various sensors and/or modules can be performed via any of the combinations of modules in the control subsystem that are not illustrated, including, but not limited to, the processing unit 434 and/or the memory unit 436.

FIG. 5 depicts an example flow for generating a hash function and hash value used for authentication, in accordance with embodiments of the present disclosure.

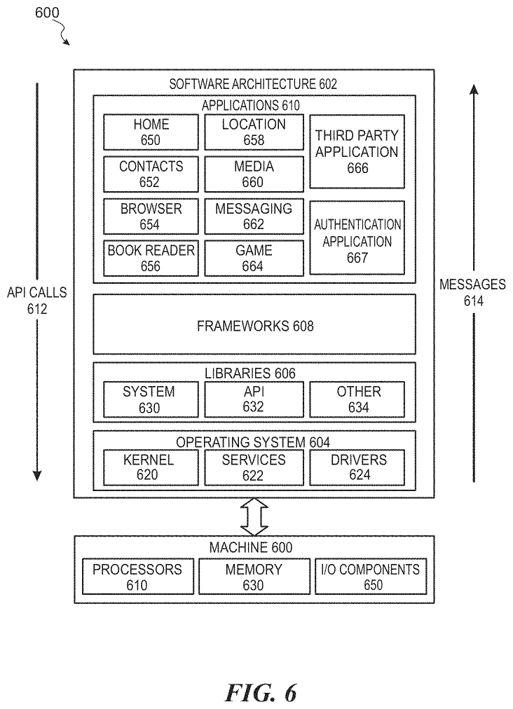

FIG. 6 is a block diagram illustrating an example of a software architecture 600 that may be installed on a machine, in accordance with embodiments of the present disclosure.

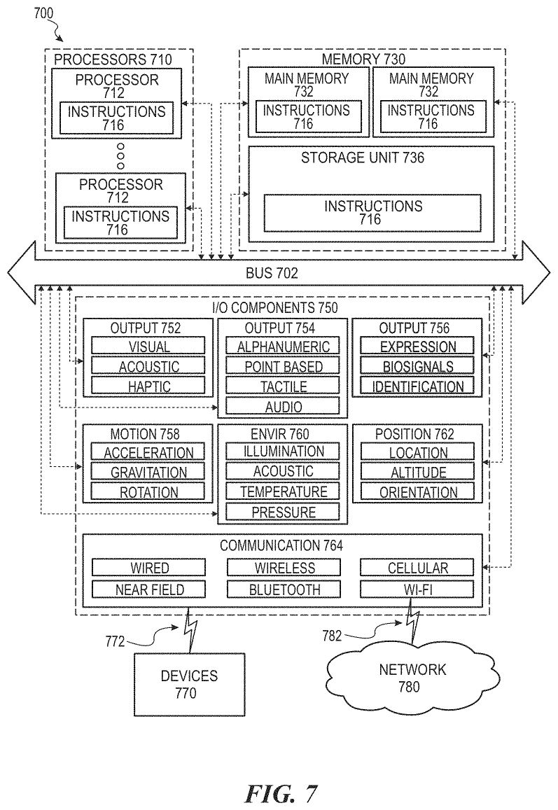

FIG. 6 is a block diagram 600 illustrating an architecture of software 602, which can be installed on any one or more of the devices described above. FIG. 6 is a non-limiting example of a software architecture, and it will be appreciated that many other architectures can be implemented to facilitate the functionality described herein. In various embodiments, the software 602 is implemented by hardware such as machine 700 of FIG. 7 that includes processors 710, memory 730, and input/output (I/O) components 750. In this example architecture, the software 602 can be conceptualized as a stack of layers where each layer may provide a particular functionality. For example, the software 602 includes layers such as an operating system 604, libraries 606, frameworks 608, and applications 610. Operationally, the applications 610 invoke API calls 612 through the software stack and receive messages 614 in response to the API calls 612, in accordance with some embodiments.

In some embodiments, the operating system 604 manages hardware resources and provides common services. The operating system 604 includes, for example, a kernel 620, services 622, and drivers 624. The kernel 620 acts as an abstraction layer between the hardware and the other software layers consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH drivers, flash memory drivers, serial communication drivers (e.g., Universal Serial Bus (USB) drivers), WI-FI drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematics functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphic user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a search/discovery application 656, a location application 658, a media application 660, a messaging application 662, a game application 664, and other applications such as a third party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third party application 666 (e.g., an application developed using the Android, Windows or iOS. software development kit (SDK) by an entity other than the vendor of the particular platform) may be mobile software running on a mobile operating system such as Android, Windows or iOS, or another mobile operating systems. In this example, the third party application 666 can invoke the API calls 612 provided by the operating system 604 to facilitate functionality described herein.

An authentication application 667 may implement any system or method described herein, including hash function creation, generation of a hash value, authentication of a tag, authentication of an object, or any other operation described herein.

FIG. 7 is a block diagram illustrating components of a machine 700, according to some example embodiments, able to read a set of instructions from a machine-readable medium (e.g., a machine-readable storage medium) and perform any one or more of the methodologies discussed herein.

Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described.

In alternative embodiments, the machine 700 operates as a standalone device or can be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 can include processors 710, memory/storage 730, and I/O components 750, which can be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 712 and processor 714 that may execute instructions 716. The term “processor” is intended to include multi-core processor that may comprise two or more independent processors (sometimes referred to as “cores”) that can execute instructions contemporaneously. Although FIG. 7 shows multiple processors, the machine 700 may include a single processor with a single core, a single processor with multiple cores (e.g., a multi-core processor), multiple processors with a single core, multiple processors with multiples cores, or any combination thereof.

The memory/storage 730 can include a main memory 732, a static memory 734, or other memory storage, and a storage unit 736, both accessible to the processors 710 such as via the bus 702. The storage unit 736 and memory 732 store the instructions 716 embodying any one or more of the methodologies or functions described herein. The instructions 716 can also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of the processors 710 are examples of machine-readable media.

As used herein, the term “machine-readable medium” or “machine-readable storage medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 716. The term “machine-readable medium” or “machine-readable storage medium” shall also be taken to include any medium, or combination of multiple media, that is capable of storing, encoding or carrying a set of instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 750 can include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 can include many other components that are not shown in FIG. 7. The I/O components 750 are grouped according to functionality merely for simplifying the following discussion and the grouping is in no way limiting. In example embodiments, the I/O components 750 can include output components 752 and input components 754. The output components 752 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 752 can include biometric components 756, motion components 758, environmental components 760, or position components 762 among a wide array of other components. For example, the biometric components 756 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 can include acceleration sensor components (e.g., an accelerometer), gravitation sensor components, rotation sensor components (e.g., a gyroscope), and so forth. The environmental components 760 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 762 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 750 may include communication components 764 operable to couple the machine 700 to a network 780 or devices 770 via a coupling 782 and a coupling 772, respectively. For example, the communication components 764 include a network interface component or other suitable device to interface with the network 780. In further examples, communication components 764 include wired communication components, wireless communication components, cellular communication components, Near Field Communication (NFC) components, Bluetooth. components (e.g., Bluetooth. Low Energy), WI-FI components, and other communication components to provide communication via other modalities. The devices 770 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 764 can detect identifiers or include components operable to detect identifiers. For example, the communication components 764 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 764, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 780 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or other type of cellular or wireless coupling. In this example, the coupling 782 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 can be transmitted or received over the network 780 using a transmission medium via a network interface device (e.g., a network interface component included in the communication components 764) and utilizing any one of a number of transfer protocols (e.g., HTTP). Similarly, the instructions 716 can be transmitted or received using a transmission medium via the coupling 772 (e.g., a peer-to-peer coupling) to devices 770. The term “transmission medium” shall be taken to include any intangible medium that is capable of storing, encoding, or carrying the instructions 716 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

What is claimed is:

1. A method for a mobile device to perform authentication using a tag, the method, comprising:
retrieving a unique identifier from the tag;
scrambling the unique identifier by the mobile device;
using a second unique identifier to determine lighting parameters to be used by the mobile device to illuminate the tag;
illuminating the tag, by the mobile device, using the lighting parameters determined from the second unique identifier;
capturing an image generated from the tag in response to illumination of the tag using the lighting parameters;
converting the image into a mathematical representation;
wherein, the mathematical representation is used as a hashing function;
computing a hash value from the hashing function.

2. The method of claim 1, wherein, the tag includes an optically diffractive surface having multiple diffractive optical elements; wherein, an appearance of the multiple diffractive elements changes when illuminated.

3. The method of claim 1, further comprising, creating a public register entry by registering the hash value on a blockchain.

4. The method of claim 1, wherein, authentication of the public register entry on the block chain is performed using a private key derived using the multiple diffractive optical elements.

5. The method of claim 4, further comprising,
computing an output value computed by using the private key on the public register entry;
determining whether the output value matches the unique identifier;
wherein, the public register entry is authenticated responsive to detecting a match between the output value and the unique identifier.

6. The method of claim 2, further comprising:
retrieving a marker from the optically diffractive surface of the tag;
wherein, the marker indicates an angle at which to illuminate the tag;
wherein, the lighting parameters are determined at least in part from the angle at which to illuminate the tag by the mobile device.

7. The method of claim 6, further comprising,
instructing a user to rotate or tilt the tag to implement the lighting parameters as determined from the marker.

8. The method of claim 6, further comprising,
instructing a user of the mobile device to rotate or tilt the mobile device to implement the lighting parameters as determined using the marker.

9. The method of claim 1, wherein, the second unique identifier is provided by another device.

10. The method of claim 1, wherein:
the unique identifier includes a printed unique identifier that is human readable.

11. The method of claim 1, wherein:
the unique identifier includes a QR code.

12. The method of claim 1, wherein:
the unique identifier is provided in an RFid.

13. The method of claim 1, wherein, the tag is formed in a sticker or label suitable for attachment or fixation onto an object.

14. The method of claim 1, wherein, authentication for the tag is only achievable with the tag.

15. The method of claim 13, wherein, the object includes one or more of a mineral, a diamond and a work of art.

16. A security device, comprising:
an optically diffractive surface having multiple diffractive elements;
wherein, the multiple diffractive elements are configured to generate a complex light wavefront in response to illumination by a light source;
wherein, the complex light wavefront is used to create a hash value for authentication;
wherein, the complex light wavefront includes digital images viewable in different planes;
a fiducial marker having machine-readable code;
wherein, the digital images are able to be uniquely discriminated relative to the fiducial marker;
wherein, the fiducial marker is substantially immutable when illuminated by the light source.

17. The security device of claim 16, wherein:
the digital images are viewable in different planes relative to a reflected signal from the light source.

18. The security device of claim 16, wherein:
a unique identifier associated with the security device is identified from parsing the fiducial marker from the digital images.

19. The security device of claim 18, wherein:
a mathematical representation of the digital images of the complex light wavefront is generated using the unique identifier.

20. The security device of claim 19, wherein:
the hash value is created from the mathematical representation of the multiplexed digital image and another mathematical representation of the fiducial marker.

21. The security device of claim 16, wherein:
the light source is provided by an LED light source.

22. The security device of claim 21, wherein:
the LED light source is provided by a mobile system.

23. The security device of claim 16, wherein:
the machine-readable code of the fiducial marker includes a barcode or QR code.

24. The security device of claim 16, wherein,
configuration data is generated for the multiple diffractive elements configured to produce the complex light wavefront;
each of the multiple diffractive optical elements is recorded by exposing a rotating photosensitive substrate medium with a single non-referenced light beam;
wherein, during the exposing, the rotating photosensitive substrate rotates at an angular velocity greater than or equal to 10 revolutions per second;
wherein the recording is performed absent other light interference of the single non-referenced light beam.

25. A machine-readable medium having stored thereon instructions which when executed by a processor, cause the processor to perform a method for authentication of an object using a tag attached to the object, the method, comprising:
retrieving a unique identifier from the tag;
scrambling the unique identifier;
computing an object value from unique features of the object;
determining a hashing function using the unique identifier and the object value;
computing a hash value from the hashing function.

26. The method of claim 25, further comprising, registering the hash value on a blockchain.

27. The method of claim 25, wherein, the object value is associated with a private key in performing the authentication of the object; further wherein, the authentication of the object is only achievable using the object.

28. The method of claim 25, wherein:
the unique identifier comprises one or more of: a florescent chemical, an optical marking viewable at different spectrums, and a thermal source activated by electromagnetic radiation.

29. The method of claim 25, wherein:
the unique identifier is detectable by LIDAR.

30. The method of claim 25, wherein:
the unique features are computed from one or more of, a mineral, a diamond and a work of art.
